(19) United States
(12) Patent Application Publication
(10) Pub. No.: US 2013/0185729 A1
(43) Pub. Date: Jul. 18, 2013

(54) ACCELERATING RESOURCE ALLOCATION IN VIRTUALIZED ENVIRONMENTS USING WORKLOAD CLASSES AND/OR WORKLOAD SIGNATURES

(71) Applicants: Nedeljko Vasic, Crissier (CH); Dejan Novakovic, Lausanne (CH); Dejan Kostic, Saint-Sulpice VD (CH); Svetozar Miucin, Petrovaradin (RS); Ricardo Bianchini, New Brunswick, NJ (US)

(72) Inventors: Nedeljko Vasic, Crissier (CH); Dejan Novakovic, Lausanne (CH); Dejan Kostic, Saint-Sulpice VD (CH); Svetozar Miucin, Petrovaradin (RS); Ricardo Bianchini, New Brunswick, NJ (US)

(73) Assignees: Rutgers, The State University of New Jersey, New Brunswick, NJ (US); Ecole Polytechnique Federale de Lausanne (EPFL), Lausanne (CH)

(21) Appl. No.: 13/411,491

(22) Filed: Mar. 2, 2012

Related U.S. Application Data
(60) Provisional application No. 61/586,713, filed on Jan. 13, 2012.
(60) Provisional application No. 61/586,712, filed on Jan. 13, 2012.

(51) Int. Cl. G06F 9/50

(52) U.S. Cl. 718/104

(57) ABSTRACT

Systems, methods, and apparatus for managing resources assigned to an application or service. A resource manager maintains a set of workload classes and classifies workloads using workload signatures. In specific embodiments, the resource manager minimizes or reduces resource management costs by identifying a relatively small set of workload classes during a learning phase, determining preferred resource allocations for each workload class, and then during a monitoring phase, classifying workloads and allocating resources based on the preferred resource allocation for the classified workload. In some embodiments, interference is accounted for by estimating and using an “interference index”.

### CROSS-REFERENCES TO RELATED APPLICATIONS

This application claims benefit under 35 U.S.C. 119(e) of U.S. Provisional Patent Application No. 61/586,712 filed on Jan. 13, 2012, which is herein incorporated by reference in its entirety for all purposes.

### BACKGROUND

Embodiments of the present invention relate to allocating resources to an application or service, and in particular to allocating resources to applications or services provided in a cloud environment.

Cloud computing is rapidly growing in popularity and importance, as an increasing number of enterprises and individuals have been offloading their workloads to cloud service providers. Cloud computing generally refers to computing wherein computing operations (“operations”) such as performing a calculation, executing programming steps or processor steps to transform data from an input form to an output form, and/or storage of data (and possibly related reading, writing, modifying, creating and/or deleting), or the like are off-loaded from a local computing system to a remote computing system with the remote computing system (i.e., the “cloud” environment) being separately managed from the local computing system.

In many cases, the cloud environment is shared among a plurality of independent users and the cloud environment includes its own cloud management logic and infrastructure to handle tasks such as computing billing details for users' use of the cloud environment, allocating computing resources and storage space (such as hard disk space or RAM space) to various user processes and initiating cloud operations. In most cases, the amount of computing power available, storage available and power consumption of a cloud environment are constrained, so efficient uses of those is desirable.

In a typical example of cloud computing, a user might operate a local computing system (such as a networked system, a desktop computer, a handheld device, a smart phone, a laptop, etc.) to initiate a computing task and the local computing system might be configured, for certain computing tasks, to represent those in part as cloud computing operations, send a set of instructions to a cloud environment for performing those cloud computing operations (including providing sufficient information for those cloud computing operations), receive results of those cloud computing operations, and perform the expected local operations to complete the computing task.

As used herein, the “user” might be a person that initiates computing tasks, or some automated and/or computer user that initiates computing tasks. Where the cloud environment is shared among multiple unrelated or independent users, a user might be referred to as a “tenant” of the cloud environment. It should be understood that the cloud environment is implemented with some computing hardware and that users/tenants use some device or computer process to initiate computing tasks. As used herein, “client” refers to the device or computer process used by a user/tenant to initiate one or more computing tasks.

Various cloud environments are known. Companies such as Amazon.com, Microsoft, IBM, and Google (“providers”) provide cloud environments that are accessible by public users via various clients. One of the main reasons for the proliferation of cloud services is virtualization, which (1) enables providers to easily package and identify each customer's application into one or more virtual machines (“VMs”); (2) allows providers to lower operating costs by multiplexing their physical machines (“PMs”) across many VMs; and (3) simplifies VM placement and migration across PMs.

Effective management of virtualized resources is a challenging task for providers, as it often involves selecting the best resource allocation out of a large number of alternatives. Moreover, evaluating each such allocation requires assessing its potential performance, availability, and energy consumption implications. To make matters worse, the workload of certain applications varies over time, requiring the resource allocations to be reevaluated and possibly changed dynamically. For example, the workload of network services may vary in terms of the request rate and the resource requirements of the request mix.

A service or application that is provisioned with an inadequate number of resources can be problematic in two ways. If the service is over-provisioned, the provider wastes resources, and also likely wastes money. If the service is under-provisioned, its performance may violate a service-level objective (“SLO”). An SLO might be a contracted-for target or a desirable target that the provider hopes to be able to provide to its user customers.

Given these problems, automated resource managers or the system administrators themselves must be able to evaluate many possible resource allocations quickly and accurately. Both analytical modeling and experimentation have been proposed for evaluating allocations in similar datacenter settings. Unfortunately, these techniques may require substantial time. Although modeling enables a large number of allocations to be quickly evaluated, it also typically requires time-consuming (and often manual) re-calibration and re-validation whenever workloads change appreciably.

In contrast, sandboxed experimentation can be more accurate than modeling, but requires executions that are long enough to produce representative results. For example, some art suggests that each experiment may require minutes to execute. Finally, experimenting with resource allocations on-line, via simple heuristics and/or feedback control, has the additional limitation that any tentative allocations are exposed to users.

Some prior approaches to managing resources have been considered, but still could be improved upon.

One approach is to use automated resource management in virtualized data centers. For example, a load-based threshold may be used to automatically trigger creation of a previously configured number of new virtual instances in a matter of minutes. This approach uses an additive-increase controller, and as such takes too long to converge to changes in the workload volume. Moreover, it does so with an unnecessarily large number of steps, each of which may require time-consuming reconfiguration.

Another approach is to apply modeling and machine learning to resource management in data centers. For example, a closed queuing network model may be used along with a Mean Value Analysis (“MVA”) algorithm for multi-tier applications. For another example, queuing-based performance models for enterprise applications may be used, but with emphasis on the virtualized environment. The accuracy of models may be significantly enhanced by explicitly modeling a non-stationary transaction mix, where the workload type (as in a different type of incoming requests to a service) is equally important as the workload volume itself. In general, most of these efforts work well for a certain workload which is used during parameter calibration, but have no guarantee when the workload changes. Further, achieving higher accuracy requires highly skilled expert labor along with a deep understanding of the application.

Yet another approach is running actual experiments instead of using models. However, this still takes time and may result in the service running with suboptimal parameters.

Even earlier, sample-based profiling was used to identify different activities running within the system. For instance, clustering may be used to classify requests and produce a workload model. Although such tools can be useful for post execution decisions, they do not provide online identification and ability to react during execution.

The problem of automatically configuring a database management system (“DBMS”) may be addressed by adjusting the configurations of the virtual machine in which they run. This is done by using information about the anticipated workload to compute the workload-specific configuration. However, their framework assumes help from the DBMS which describes a workload in the form of a set of SQL statements.

In view of the difficulties of cloud computing environments, improvements would be welcomed.

### BRIEF SUMMARY

Embodiments of the present invention overcome some or all of the aforementioned deficiencies in the related art. According to some embodiments, methods, apparatuses, and systems for allocating resources are disclosed. A resource management system is disclosed, where the system is usable in distributed computing environments wherein computing resources are allocated among a plurality of applications that would consume those computing resources and are allocated portions of those computing resources. The resource management system may include a monitor operable to receive client requests directed to an application, a profiler operable to compute a workload signature for each workload of a clone of the application that results from the clone serving the client requests, a clusterer operable to cluster workloads, and a tuner operable to map each cluster to a resource allocation.

In another embodiment, another resource management system is disclosed, where the system is usable in distributed computing environments wherein computing resources are allocated among a plurality of applications that would consume those computing resources and are allocated portions of those computing resources. The resource management system according to this embodiment may include a monitor operable to receive client requests directed to an application, a profiler operable to compute a workload signature for a workload of a clone of the application that results from the clone serving the client requests, a classifier operable to classify the workload signature using previously defined workload classes, and a resource allocator operable to cause a number of resources to be allocated to the application defined by a resource allocation associated with a workload class that matches the workload signature.

In one embodiment, a method of modeling an application is also disclosed. The method includes receiving client requests, serving the client requests using an application, computing workload signatures for the application, generating at least one workload class based on the workload signatures, and determining resource allocations for each workload class.

In another embodiment, a method of allocating resources to an application is disclosed. The method includes receiving a client request, serving the client request using the application, computing a workload signature for the application, comparing the workload signature to at least one workload class associated with the application, and causing resources to be allocated to the application based on the comparison.

For a more complete understanding of the nature and advantages of embodiments of the present invention, reference should be made to the ensuing detailed description and accompanying drawings. Other aspects, objects and advantages of the invention will be apparent from the drawings and detailed description that follows. However, the scope of the invention will be fully apparent from the recitations of the claims.

### BRIEF DESCRIPTION OF THE DRAWINGS

FIG. 1 shows a resource management system and a way it may be integrated with the computing systems of a cloud provider in accordance with an embodiment.

FIG. 2 shows elements of a resource management system according to an embodiment.

FIG. 3 illustrates operations of the resource management system according to various embodiments.

FIG. 4 illustrates a method of profiling a multi-tier service according to one embodiment.

FIG. 5(a) show the results of running the SPECweb2009 cloud benchmark.

FIG. 5(b) show the results of running the RUBiS cloud benchmark.

FIG. 5(c) show the results of running the Cassandra cloud benchmark.

FIG. 6 shows representative workload classes obtained from a service after replaying the day-long Microsoft HotMail trace.

FIG. 7(a) shows a sequence of operations for modeling an application or service.

FIG. 7(b) shows a sequence of operations for allocating resources to an application.

FIG. 8(a) shows a normalized load trace of Windows Live Messenger.

FIG. 8(b) shows the number of active server instances as the workload intensity changes according to the Windows Live Messenger load trace.

FIG. 8(c) shows the service latency as the resource management system adapts to workload changes resulting from Windows Live Messenger.

FIG. 9(a) shows a normalized load trace of Windows Live Mail.

FIG. 9(b) shows the number of active server instances as the workload intensity changes according to the Windows Live Mail load trace.

FIG. 9(c) shows the service latency as the resource management system adapts to workload changes resulting from Windows Live Mail

FIG. 10 shows the average adaptation time for the resource management system and RightScale (assuming its default configuration) for the Hotmail and Messenger traces

FIG. 11(a) shows the provisioning cost, shown as the instance type used to accommodate the HotMail load over time, where the instance type varies between large and extra-large.

FIG. 11(b) shows the service latency as the resource management system adapts to Hotmail workload changes.

FIG. 12(a) shows the provisioning cost, shown as the instance type used to accommodate the Messenger load over time, where the instance type varies between large and extra-large.

FIG. 12(b) shows the service latency as the resource management system adapts to Messenger workload changes.

FIG. 13(a) shows the service latency as the resource management system adapts to workload changes with interference detection disabled and enabled.

FIG. 13(b) shows the number of virtual instances used to accommodate the load when interference detection is enabled.

FIG. 14 is a diagram of a computer apparatus according to some embodiments.

FIG. 15 shows the amount of latency resulting from the incremental and decremented changes in workload volume every 10 minutes for an experiment using RUBiS.

### DETAILED DESCRIPTION

As explained herein in greater detail, a cloud computing resource manager can addresses various problems of cloud computing allocation and management while simplifying and accelerating the management of virtualized resources in cloud computing services.

In one aspect, the resource management system caches and reuses results of prior resource allocation decisions in making current resource allocation decisions. When the resource management system detects that workload conditions have changed (perhaps because a VM or service is not achieving its desired performance), it can lookup the data stored in its cache, each time using a VM identification and a “workload signature” related to various characteristics.

The workload signature may be an automatically determined, pre-defined vector of metrics describing the workload characteristics and the VM's current resource utilization. To enable the “cache lookups,” the resource management system may automatically constructs a classifier that can use, e.g., off-the-shelf machine learning techniques. The classifier operates on workload clusters that are determined after an initial learning phase. Clustering has a positive effect on reducing the overall resource management effort and cost, because it reduces the number of invocations of the tuning process (one per cluster).

The resource manager can thus quickly reallocate resources. The manager only needs to resort to time-consuming modeling, sandboxed experimentation (e.g., a stand-alone or insulated environment for running a program without interfering with other programs), or on-line experimentation when no previous workload exercises the affected VMs in the same way. When the manager does have to produce a new optimized resource allocation using one of these methods, it stores the allocation into its cache for later reuse.

The resource management system is particularly useful when its cached allocations can be repeatedly reused as opposed to where each allocation is unpredictable and unique. Although the resource management system can be used successfully in a variety of environments, here the examples used are largely related to cloud computing provided by providers that run collections of network services (these are also known as “Web hosting providers”). One skilled in the art would readily recognize how the resource manager described herein in the context of cloud computing could be extended to other computing contexts.

It is well-known that the load intensity of network services follows a repeating daily pattern, with lower request rates on weekend days. In addition, these services use multiple VMs that implement the same functionality and experience roughly the same workload (e.g., all the application servers of a 3-tier network service).

Some embodiments described herein deal with performance interference on the virtualized hosting platform by recognizing the difficulty of pinpointing the cause of interference and the inability of cloud users to change the hosting platform itself to eliminate interference. The resource management system uses a pragmatic approach in which it probes for interference and adjusts to it by provisioning the service with more resources.

As explained in more detail below, the resource management system can learn and reuse optimized VM resource allocations. Also described are techniques for automatically profiling, clustering and classifying workloads. Clustering reduces the number of tuning instances and thus reduces the overall resource management cost.

Also described herein are experimental results from specific implementations.

Deploying the resource management system in accordance with some of the embodiments described herein can result in multiple benefits. For example, it may enable cloud providers to meet their SLOs more efficiently as workloads change. It may also enable providers to lower their energy costs (e.g., by consolidating workloads on fewer machines, more machines can enter a low-power state). In addition, the lower providers' costs may translate into savings for users as well.

In this disclosure, references to “we” in connection with steps, apparatus or the like, such as “we do” or “we use” can be interpreted as referring to the named inventors but can also can be interpreted as referring to hardware, software, etc., or combinations in various devices, platforms or systems that perform the steps and/or embody the apparatus, as should be apparent to one of ordinary skill in the art upon reading this disclosure.

### BACKGROUND

In specific examples described herein—not meant to be limiting—we assume that the user of the virtualized environment deploys her service across a pool of virtualized servers. We use the term “application” to denote a standalone application or a service component running within a guest operating system in a virtual machine (“VM”). The service itself may be mapped to a number of VMs. A typical example would be a 3-tier architecture comprising a web server, an application server, and a database server component. All VMs reserved for a particular component can be hosted by a single physical server, or distributed across a number of them. The user and the provider agree on the Service Level Objective (“SLO”) for the deployed service. Herein, we use the terms “user” and “tenant” interchangeably. We reserve the term “client” for the client of the deployed service itself

While the resource management system is not restricted to any particular virtualized platform, we evaluated it using Amazon's Elastic Computing Cloud (“EC2”) platform. EC2 offers two mechanisms for dynamic resource provisioning, namely horizontal and vertical scaling. While horizontal scaling (scaling out) lets users quickly extend their capacities with new virtual instances, vertical scaling (scaling up) varies resources assigned to a single node. EC2 provides many server instance types, from small to extra large, which differ in available computing units, memory and I/O performance. We evaluated the resource management system with both provisioning schemes in mind.

One issue in resource provisioning is to come up with the sufficient, but not wasteful, set of virtualized resources (e.g., number of virtual CPU cores and memory size) that enable the application to meet its SLO. Resource provisioning is challenging due to: 1) workload dynamics, 2) the difficulty and cost of deriving the resource allocation for each workload, and 3) the difficulty in enforcing the resource planning decisions due to interference. As a result, it is difficult to determine the resource allocation that will achieve the desired performance while minimizing the cost for both the cloud provider and the user.

An important problem is that the search space of allocation parameters is very large and makes the optimal configuration hard-to-find. Moreover, the workload can change and render this computed setting sub-optimal. This in turn results in under-performing services or resource waste.

Once they detect changes in the workload, the existing approaches for dynamic resource allocation re-run time-consuming modeling and validation, sandboxed experimentation, or on-line experimentation to evaluate different resource allocations. Moreover, on-line experimentation approaches (including feedback control) adjust the resource allocation incrementally, which leads to long convergence times. The convergence problem becomes even worse when new servers are added to or removed from the service. Adding servers involves long boot and warm-up times, whereas removing servers may cause other servers to spend significant time rebalancing load.

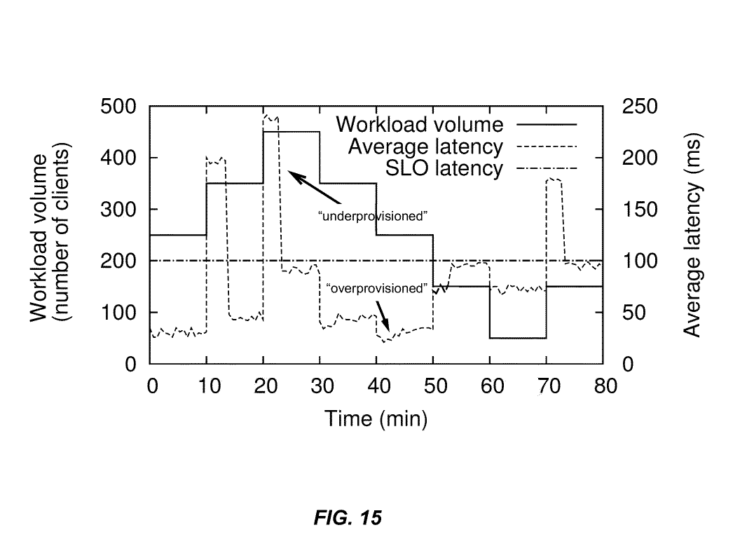

The impact of the state-of-the-art online adaptation on performance is illustrated by our experiment using RUBiS (an eBay clone) in which we change the workload volume every 10 minutes. Further, to approximate the diurnal variation of load in a datacenter, we vary the load according to a sine-wave. FIG. 15 shows the amount of latency resulting from the incremental and decremented changes in workload volume every 10 minutes. As shown in FIG. 15, even if the workload follows a recurring pattern, the existing approaches are forced to repeatedly run the tuning process since they cannot detect the similarity in the workload they are encountering. Unfortunately, this means that the hosted service is repeatedly running for long periods of time under a suboptimal resource allocation. In some cases, such as that indicated by “underprovisioned” in FIG. 15, the service can deliver insufficient performance due to a lack of resources, while in other instances, such as that indicated by “overprovisioned”, the service can ultimately waste resources. Further, a small magnitude of response latency increase, such as 100 ms, has substantial impact on the revenue of the service. Finally, computing the optimal resource allocation might be an expensive task.

When faced with such long periods of unsatisfactory performance, the users might have to resort to overprovisioning, e.g., by using a large resource cap that can ensure satisfactory performance at foreseeable peaks in the demand. For the user, doing so incurs unnecessarily high deployment costs. For the provider, this causes high operating cost (e.g., due to excess energy for running and cooling the system). In summary, overprovisioning negates one of the primary reasons for the attractiveness of virtualized services for both users and providers.

Another problem with existing resource allocation approaches is that virtualization platforms do not provide ideal performance isolation, especially in the context of hardware caches and I/O. This implies that application performance may suffer due to the activities of the other virtual machines co-located on the same physical server. Due to such interference, even virtual instances of the same type might have very different performance over time.

### 1. Overview of an Implementation

An implementation of a resource management system according to various embodiments of the present invention is described herein. The resource management system can operate alongside the services deployed in the virtualized environment of a cloud provider. In the embodiments described herein, the cloud provider itself deploys and operates the resource management system. However, ion other embodiments, other organizations may operate to deploy and operate the resource management system.

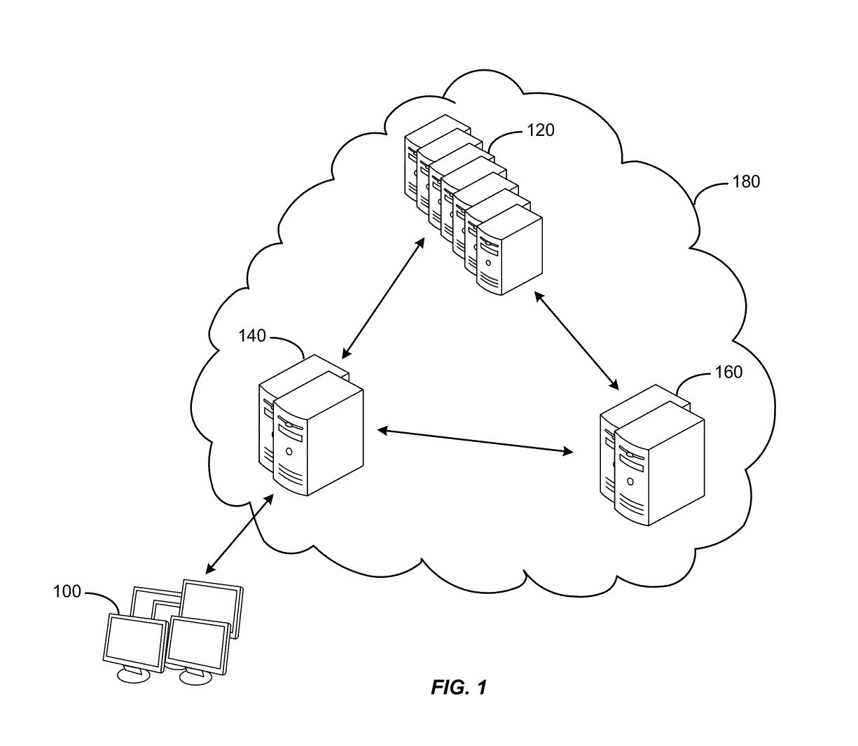

FIG. 1 shows a resource management system and a way it may be integrated with the computing systems of a cloud provider in accordance with an embodiment. A client computing device 100 may be associated with a user desiring to access one or more application or services hosted by the cloud provider. The client computing device 100 may be any suitable computing device, such as a desktop computer, a portable computer, a cell phone, etc., and may include any suitable components (e.g., a storage element, a display, a graphical user interface, a computer processor, etc.) such that the client computing device 100 is operable to perform the functionality discussed herein.

The user associated with the client computing device 100 may initiate one or more computing tasks provided by a production system 120. The production system 120 may execute one or more applications and/or services, thereby providing a cloud environment accessible by the user associated with the client computing device 100. Accordingly, the production system 120 may be operable to package and identify each customer's application into one or more VMs, and may include one or more PMs that may be multiplexed across many VMs. The production system 120 may have a limited number of computing resources, and thus operate to provide and manage a limited number of virtualized resources operable to facilitate execution of applications and/or services. The production system 120 may include any suitable hardware and/or software components operable to perform the functionality discussed herein with respect to the production system 120, including processor(s), storage element(s), interface element(s), etc. Further, while only one production system 120 is depicted in FIG. 1, one of ordinary skill in the art would recognize that numerous production systems could be included, where the production systems may execute the same or different applications and/or services.

A proxy server 140 may be provided between the client computing device 100 and the production system 120. In many embodiments discussed herein, the proxy server 140 is discussed as being part of the resource management system, whereas in other embodiments the proxy server 140 and as depicted in FIG. 1 may be separate from the resource management system 160. The proxy server 140 may be a stand-alone server or, in some embodiments, may execute on other elements, such as the production system 120. The proxy server 140 may receive client requests from the client device 100 and pass the client requests through to the production system 120. The proxy server 140 may also copy some or all of the client requests and forward the copied requests to the resource management system 160. The proxy server 140 may include any suitable hardware and/or software components operable to perform the functionality discussed herein with respect to the proxy server 140, including processor(s), storage element(s), interface element(s), etc. Further, while only one proxy server 140 is depicted in FIG. 1, one of ordinary skill in the art would recognize that numerous proxy servers could be included, where the proxy servers may forward client requests to the same or different production systems 120.

The resource management system 160 may be any single or network of computing devices operable to perform some or all of the functions discussed herein with respect to the resource management system. In some embodiments, the resource management system 160 may be operable to receive information such as client requests from one or more client computing devices 100 via the proxy server 140 and, in some cases, cause the number and/or type of resources that the production system 120 allocates to various applications and/or services. The resource management system 160 may include any suitable hardware and/or software components operable to perform the functionality discussed herein with respect to the resource management system 160, including processor(s), storage element(s), interface element(s), etc. In some embodiments, the resource management system 160 may be operable to receive information such as client requests from one or more client computing devices 100 via the proxy server 140 and, in some cases, cause the number and/or type of resources that the production system 120 allocates to various applications and/or services.

The network 180 is any suitable network for enabling communications between various entities, such as between the client computing device 100, production system 120, proxy server 140, and the resource management system 160. Such a network may include, for example, a local area network, a wide-area network, a virtual private network, the Internet, an intranet, an extranet, a public switched telephone network, an infrared network, a wireless network, a wireless data network, a cellular network, or any other such network or combination thereof. The network may, furthermore, incorporate any suitable network topology. Examples of suitable network topologies include, but are not limited to, simple point-to-point, star topology, self organizing peer-to-peer topologies, and combinations thereof. Components utilized for such a system may depend at least in part upon the type of network and/or environment selected. The network 180 may utilize any suitable protocol, such as TCP/IP, OSI, FTP, UPnP, NFS, CIFS, and AppleTalk. Communication over the network may be enabled by wired or wireless connections, and combinations thereof

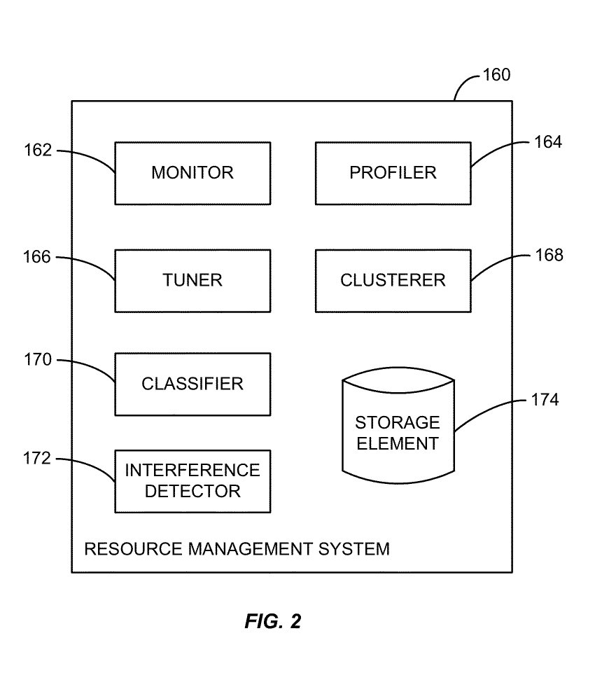

FIG. 2 shows elements of the resource management system 160 according to an embodiment. The resource management system 160 includes one or more of a monitor 162, a profiler 164, a tuner 166 (i.e., resource allocator), a clusterer 168, a classifier 170, an interference detector 172, and a storage element 174. Each of the elements of the resource management system 160 may be implemented in hardware and/or software, such as in computer code stored in a tangible non-transitory storage element 174. The functionality of each element of the resource management system 160 is further discussed herein.

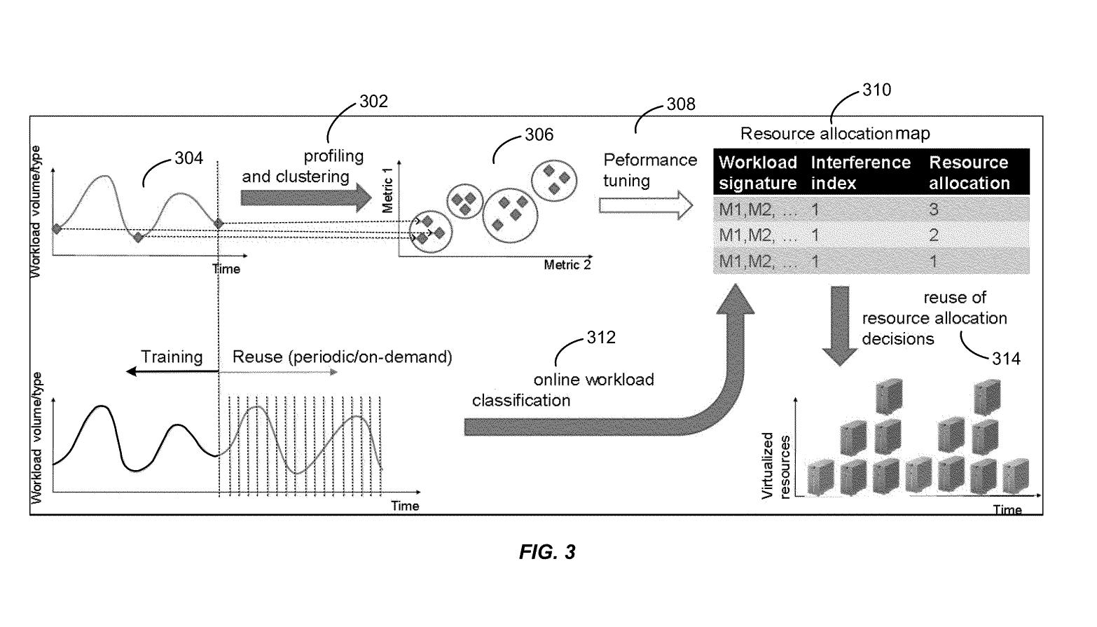

FIG. 3 illustrates operations of the resource management system 160 according to various embodiments. In general, the resource management system 160 first profiles and clusters 302 a dynamic workload 304 during a learning phase resulting in a clustering 306 of the workload 304. The resource management system 160 then performs a tuning process 308 wherein the workload clusters are mapped to virtualized resources, and the resulting resource allocation map 310 is stored by the resource management system 160. During runtime, either periodically or on-demand, the resource management system 160 profiles and classifies the workload 312, and then reuses previous resource allocation decisions 314 to allow the service to quickly adapt to workload changes. Details of these various operations are further discussed herein.

The resource management system 160 can accelerate the management of virtualized resources in datacenters (e.g., the production system 120) by caching the results of past resource allocation decisions and quickly reusing them once it faces the same, or a similar, workload. For the resource management system 160 to be effective in dealing with dynamic workloads, it first learns about workloads and their associated resource allocations (e.g., the number and size of the required virtualized instances on the production system 120) during a learning phase (e.g., a week of service use, a month of service use, a number of days of service use greater than or less than a week, a number of days of service use greater than or less than a month, etc.).

To profile a workload, the resource management system 160 deploys a proxy 140 that duplicates client requests sent from the client computing device 100 to selected service VM instances executing on the production system 120 and sends the duplicates to the profiler 164 of the resource management system 160. The resource management system 160 can then use a dedicated profiling machine (e.g., the profiler 164) to compute a “workload signature” for each encountered workload. The workload signature itself may be a set of automatically chosen low-level metrics. Further, the resource management system 160 “clusters” the encountered workloads using, e.g., a clusterer 168, and by doing so it reduces the resource management overhead, as well as the number of potentially time-consuming service reconfigurations to accommodate more or fewer virtual machines. The tuner 166 of the resource management system 160 maps the clusters to the available virtualized resources, and populates a resource allocation map provided in, e.g., the storage element 174 of the resource management system.

After the initial learning phase, the resource management system 160 profiles the workload periodically or on-demand (e.g., upon a violation of an SLO) using the proxy server 140. The classifier 170 of the resource management system 160 then uses each computed workload signature to automatically classify the encountered workload. If the classifier 170 points to a previously seen workload (cache hit), the resource management system 160 quickly reuses the previously computed resource allocation. In case of a different resource allocation, the resource management system 160 instructs the service to reconfigure itself. In case of a failure to classify the workload (e.g., due to an unforeseen increase in service volume) the resource management system 160 can either reinvoke the tuner 166, or instruct the service executing on the production system 120 to deploy its full capacity configuration. Compared to previous approaches, the resource management system 160 drastically reduces the time during which the service is running with inadequate resources. This translates to fewer and shorter SLO violations, as well as a significant cost reduction for running the service itself.

To deal with interference from collocated workloads, the resource management system computes an “interference index” by contrasting the performance of the service on the profiler with that in the production environment. It then stores this information in the resource allocation map. Simply put, this information tells the resource management system how many more resources it needs to request to have a better probabilistic guarantee on the service performance. Using the historically collected interference information once again allows the resource management system to reduce the tuning overhead relative to the interference oblivious case.

### 1.1. Workload Dispatching and Profiling

To profile workloads under real-world conditions and traces, the resource management system 160 may include a proxy (e.g., proxy server 140) between the clients (e.g., client computing device 100) and the hosted services (e.g., those executing on the production system 120). The proxy server 140 forwards the client requests sent from the client computing device 100 to the production system 120, and also duplicates and sends a certain fraction of the requests to the profiling environment (e.g., the profiler 164) for workload characterization.

### 1.1.1. Proxy Server

The proxy server may carefully select requests for profiling, so that the results are usable. In the case of Internet services, the sampling can be done at the granularity of the client session to avoid issues with nonexistent web cookies that might cause workload anomalies. Other types of applications may require more sophisticated approaches. For example, a distributed key-value storage system may require sampling where the proxy server needs to be aware of the node partitioning scheme and duplicate only the requests with keys that belong to the particular server instance used for workload characterization.

In some embodiments, workload characterization operates with an arbitrary service. This in turn poses a need for a general proxy that can work with any service. Hence, in some embodiments, a novel proxy is provided which sits between the application and transport layers.

The proxy duplicates incoming network traffic (e.g., some or all of the requests) of the server instance that the resource management system 160 intends to profile, and forwards it to a clone of the server instance being profiled, where the clone is provided by the resource management system 160 (e.g., by the profiler 164) and discussed further below. By doing so, the resource management system 160 ensures that the clone VM serves the same requests as the profiled instance, resulting in the same or similar behavior. Finally, to make the profiling process transparent to the other nodes in the cluster, the clone's replies may be dropped by the profiler 164. To avoid instrumentation of the service (e.g., changing the listening ports), incoming traffic to the proxy may be transparently redirected using iptables routines.

It is particularly hard to make the profiler 164 behave just like the production instance in multi-tier services. For example, consider a three-tier architecture provided in the production system 120. In this architecture, it is common for the front-end web server to invoke the application server which then talks to the database server before replying back to the front-end. In this case, if the resource management system 160 is instructed to profile only the application server (the middle tier), we need to deal with the absence of the database server.

The resource management system 160 addresses this challenge by having the proxy server 140 cache recent answers from the database in the production system 120 such that they can be re-used by the profiler 164. The answers are associated with the requests by, e.g., performing a hash on the request and associating the hash with the answer. Requests coming from the clone are also sent to the proxy server 140. Upon receiving a request from the profiler 164, the proxy identifies the answer received from the production system that is associated with the request and sends the answer back to the profiler. For example, the proxy server 140 may compute the hash of the request and mimic the existence of the database by looking up the most recent answer for the given hash. Note that the proxy's lookup table exhibits good locality since both the production system 120 and the profiler 164 deal with the same requests, only slightly shifted in time as one of these two might be running faster. This caching scheme does not necessarily produce the exact same behavior as in the production system 120 because the proxy server 140 can: i) miss some answers due to minor request permutations (i.e., the profiler 164 and the production instance generate different timestamps), or ii) feed the profiler with obsolete data. However, the scheme still generates the load on the profiler 164 that is similar to that of the production system (recall that the resource management system does not need a verbatim copy of the production system).

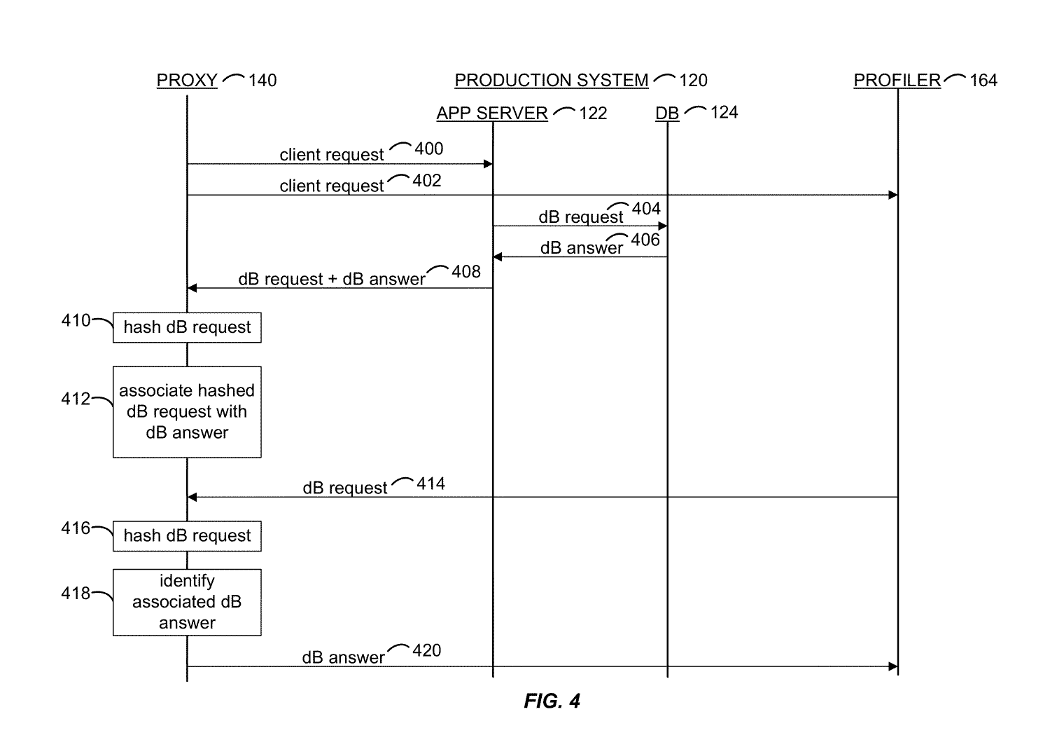

FIG. 4 illustrates a method of profiling a multi-tier service according to one embodiment. According to this embodiment, the production system 120 includes a multi-tier service where a front-end web server (not shown) invokes an application server 122 to talk to a database server 124. One of ordinary skill in the art would recognize that embodiments are not limited to these particular types of servers, but could be any suitable device, application, and/or service provided for the multi-tier service.

In operations 400 and 402, respectively, the proxy sends a client request to the application server of the production system 120 and the profiler 164 of the resource management system 160. The client request attempts to invoke an application server to talk to a database server. In the production system 120, the application server 122 accordingly sends a database request to the database 124 in operation 404 and in response receives an answer from the database in operation 406. The database request and answer received by the application server 122 are then send to the proxy 140 in operation 408.

In operation 410, the proxy 140 computes a hash of the database request and, in operation 412, associates the hash of the database request with the database answer. In some embodiments, the proxy 140 may not perform a hash of the database request, but rather may associate the database request or information identifying the database request to the database answer or information identifying the database answer.

The profiler 169 in this embodiment profiles the application server 122. However, since the profiler 164 does not include a database server, the profiler 164 sends the database request back to the proxy 140 in operation 414. In response, the proxy 140 performs a hash of the database request in operation 416 and, in operation 418, identifies the database answer associated with the hashed database request. In some embodiments, the proxy 140 may not perform a hash of the database request, but rather may identify the database answer associated with the received database request. The proxy 140 may identify the database answer by comparing the database request received in operation 414 (or a hash thereof) with one or more database requests received in operation 408 and, if there is a match, return the database answer received in operation 408 that is associated with the database request. The database answer may then be provided to the profiler 169 in operation 420.

### 1.1.2. Profiler

During the workload characterization process, the profiler 164 serves realistic requests (sent by the proxy server 140) in the profiling environment, allowing it to collect all the metrics required by the characterization process, without interfering with the production system 120. The resource management system 160 relies on VM cloning to reconstruct at least a subset of the monitored service that can serve the sampled requests, and in some embodiments makes sure that VM clones have different network identities. The clone may be executed by any suitable element(s) of the resource management system 160, and in some embodiments is executed by the profiler 164. To minimize the cloning cost, the resource management system 160 may profile only a subset of the service. For example, in one embodiment, the resource management system 160 may profile a single server instance (e.g., one VM per tier) and assume that the services balance their load evenly across server instances.

The services with little or no state may be quickly brought to an operational state which is similar to, or the same as, that of the production system 120. In contrast, replicating a database instance might be time consuming, and it is important to consider the cloning of disk storage. However, exactly capturing a service's complex behavior and resulting performance is not required, as in some embodiments only a current workload needs to be labeled. This provides additional flexibility, as the VM clone does not need to be tightly synchronized with the production system 120. Instead, periodic synchronization can be used as long as the resource management system 160 manages to identify the minimal set of resources that enable the service to meet its SLO.

To avoid the VM cloning and resource management system 160 overhead altogether, in some embodiments profiling may be performed profiling on-line, without cloning the monitored VM. Some metrics might be disturbed by co-located tenants during the sampling period, so the resource management system 160 should carefully identify signature-forming metrics that are immune to interference. The cloud provider may need to make all low-level metrics available for profiling.

### 1.2. Choosing the Workload Signature

For any metric-based workload recognition, the set of metrics chosen as the workload signature should uniquely identify all types of workload behaviors. Before going into the details of a workload signature selection process, we discuss how the workload-describing metrics may be collected.

The resource management system 160 may include a monitor 162 that periodically or on-demand (e.g., upon a violation of an SLO) collects the workload signatures. The design of the monitor 162 addresses several key challenges.

First, the monitor 162 may be operable to perform nonintrusive monitoring. Given a diverse set of applications that might be running in the cloud (e.g., on the production system 120), the resource management system 160 cannot rely on any prior service knowledge, semantics, implementation details, highly-specific logs etc. Further, the resource management system 160 may assume that it has to work well without having any control over the guest VMs or applications running inside them. This may be a desirable constraint given that, in some embodiments, hosting environments like Amazon's EC2 that provide only a “barebones” virtual server are targeted.

Second, the monitor 162 may isolate the monitoring and subsequent profiling of different applications and/or services. Because the profiler 164 (possibly running on a single machine) might be in charge of characterizing multiple cloud services, the obtained signatures should not be disturbed by other profiling processes running on the same profiler.

Third, the monitor 162 may operate using a small overhead. Since the resource management system 160 may, in some embodiments, run all the time, it should ensure that its proxy (e.g., proxy 140) induces negligible overhead while duplicating client requests, to avoid impact on application performance.

Using low-level metrics to capture the workload behavior is attractive as it allows the resource management system 160 to uniquely identify different workloads without requiring knowledge about the deployed service. The virtualization platforms may be already equipped with various monitoring tools that might be used. For instance, Xen's xentop command reports individual VM resource consumption (CPU, memory, and/or I/O). Further, modern processors usually have a set of special registers that allow monitoring of performance counters without affecting the code that is currently running

These hardware performance counters (“HPCs”) can be used for workload anomaly detection and online request recognition. In addition, the HPC statistics can conveniently be obtained without instrumenting the guest VM. Using these predictions, a scheduler can get the maximum performance out of a multiprocessor system, and still avoid overheating of system components. The HPCs may also be useful in understanding the behavior of Java applications.

The resource management system 160 may, in some embodiments, only need to read a hardware counter value before a VM is scheduled, and right after it is preempted. The difference between the two gives the resource management system 160 the exact number of events for which the VM should be “charged” for. Various tools may be implemented that provide this functionality with passive sampling.

As for the reliability of these metrics to serve as a reliable signature to distinguish different workloads, the resource management system 160 may assume that as long as a relevant counter value lies in a certain interval, the current workload belongs to the class associated with the given interval.

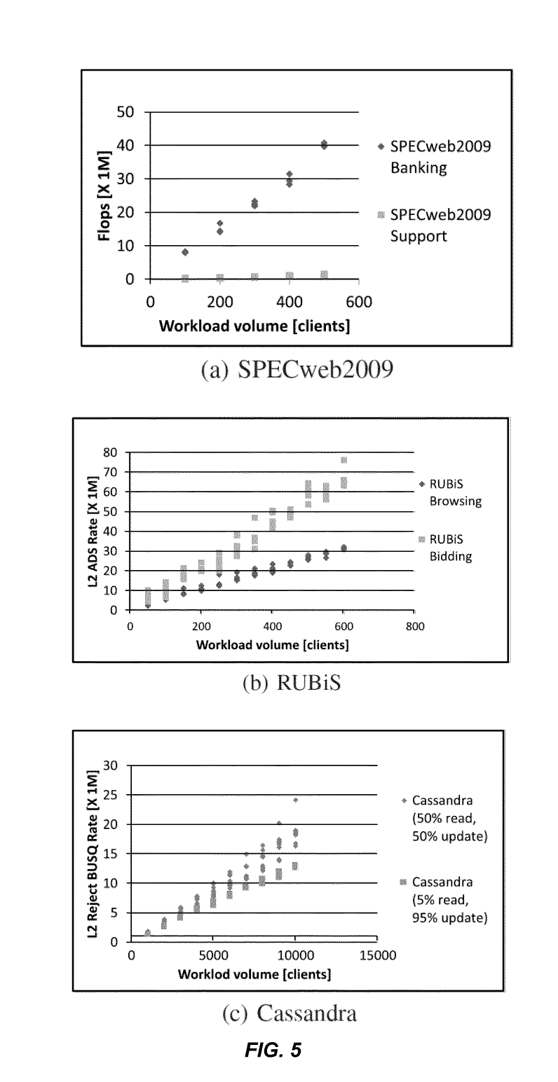

To validate this assumption in practice, we ran experiments with realistic applications. In particular, we ran typical cloud benchmarks under different load volumes, with 5 trials for each volume. FIGS. 5(a) to 5(c) present the results of running the typical cloud benchmarks under different load volumes with each point representing a different trial. In the most obvious example, FIG. 5(a) shows the results of running SPECweb2009. FIG. 5(a) clearly shows that the hardware metric (Flops rate in this case) can reliably differentiate the incoming workloads. Moreover, the results for each load volume are very close. Once we change either workload type (e.g., read/write ratio) or intensity, a large gap between counter values appear. FIG. 5(b) shows the results of running RUBiS, while FIG. 5(c) shows the results of running Cassandra. Similar trends are seen in these other benchmarks as well, but with a bit more noise. Nevertheless, the remaining metrics that belong to the signature (we are plotting only a single counter for each benchmark) typically eliminate the impact of noise.

While we can choose an arbitrary number of xentop-reported metrics to serve as the workload signature, the number of HPC-based metrics may be limited in practice—for instance, our profiling server, Intel Xeon X5472, has only four registers that allow monitoring of HPCs, with up to 60 different events that can be monitored. It is possible to monitor a large number of events using time-division multiplexing, but this may cause a loss in accuracy. Moreover, many of these events are not very useful for workload characterization as they provide little or no value when comparing workloads. Finally, we can reduce the dimensionality of the ensuing classification problem and significantly speed up the process by selecting only a subset of relevant events.

The task at hand is a typical feature selection process which evaluates the effect of selected features on classification accuracy. The problem has been investigated for years, resulting in a large number of machine learning techniques. Those existing techniques can be used for the classification here, perhaps by applying various mature methods from the WEKA machine learning package on our datasets obtained from profiling (Section 1.3). During this phase, we form the dataset by collecting all HPC and xentop-reported metric values.

Applying different techniques on our dataset, we note that the CfsSubsetEval technique, in collaboration with the GreedStepWise search, results in a high classification accuracy. The technique evaluates each attribute individually, but also observes the degree of redundancy among them internally to prevent undesirable overlap. As a result, we derive a set of N representative HPCs and xentop-reported metrics, which serve as the workload signature (WS) in the form of an ordered N-tuple of Equation 1, where a represents the metric i.

WS={m¹, m², . . . , m^{N}} (Eqn. 1)

We further analyze the feature selection process by manually inspecting the chosen counters. For instance, the HPC counters chosen to serve as the workload signature in case of the RUBiS workload are depicted in Table 1 (the xentop metrics are excluded from the table). Indeed, the signature metrics provide performance information related to CPU, cache, memory, and the bus queue.

TABLE 1

| Name | Description |
|---|---|
| Busq_empty | Bus queue is empty |
| 12_ads | Cycles the L2 address bus is in use |
| 12_st | Number of L2 data stores |
| store_block | Events pertaining to stores |
| cpu_clk_unhalted | Clock cycles when not halted |
| 12_reject_busq | Rejected L2 cache requests |
| load_block | Events pertaining to loads |
| page_walks | Page table walk events |

Given that the selection process is data-driven, the metrics forming the workload signatures are application-dependent. We however do not view this as an issue since the metric selection process is fully automated and transparent to the user.

To ensure that our workload signature is robust to arbitrary sampling duration, in some embodiments the values may be normalized with the sampling time. This is important as it allows signatures to be generalized across workloads regardless of how long the sampling takes.

### 1.3. Identifying Workload Classes

Given that the majority of network services follow a repeating daily pattern, the resource management system 160 can achieve high “cache hit rates” by populating preferred resource allocations for representative workloads, i.e., those workloads that will most likely reoccur in the near future and result in a cache hit.

There is a tradeoff between the cost of adjusting resource allocations (tuning) and the achieved hit rates. One can achieve high hit rates by naively marking every workload as representative. However, this may cause the resource management system 160 to perform costly tuning for too many workloads. On the other hand, omitting some important workloads could lead to unacceptable resource allocations during certain periods.

In some embodiments, the resource management system 160 addresses this tradeoff by automatically identifying a small set of workload classes for a service. First, it monitors the service (using, e.g., the monitor 162) for a certain period (e.g., a day or week) until the administrator decides that the resource management system 160 has seen most, or ideally all, workloads. During this initial profiling phase, the resource management system 160 collects the low-level metrics discussed in Section 1.2. Then, it analyzes the dataset (using, e.g., the profiler 164) to identify workload signatures, and may represent each workload as a point in N-dimensional space (where N is the number of metrics in the signature). Finally, the resource management system 160 clusters (using, e.g., clusterer 118) workloads into classes.

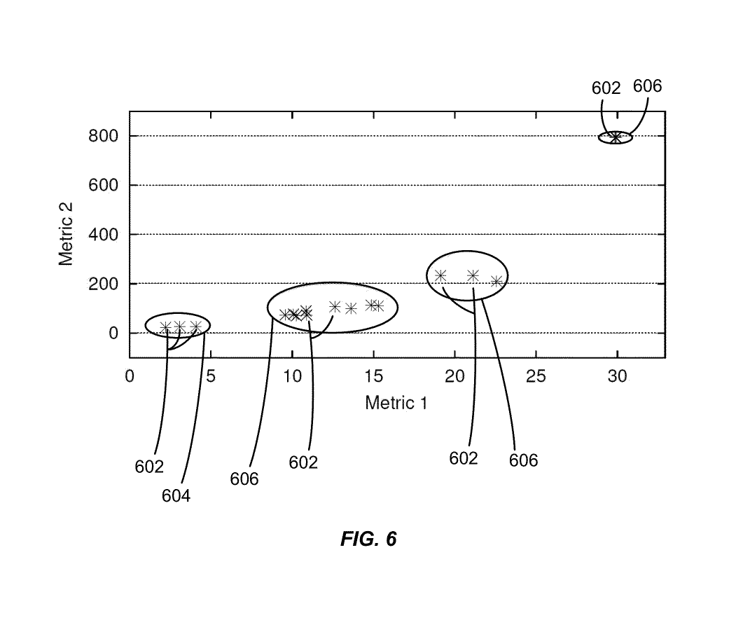

The clusterer 168 may leverage a standard clustering technique, such as simple k means, to produce a set of workload classes for which the tuner 166 needs to obtain the resource allocations. The clusterer 168 can automatically determine the number of classes, as we did in our experiments, but also allows the administrators to explicitly strike the appropriate tradeoff between the tuning cost and hit rate. As an example, FIG. 6 shows the representative workload classes that we obtain from a service after replaying the day-long Microsoft HotMail trace. Each workload is projected onto the two-dimensional space for clarity. The resource management system 160 collected a set of 24 workloads 602 (an instance per hour), and it identified only four different workload classes 604, 606, 608, 610 for which it has to perform the tuning For instance, a workload class holding a single workload (the top right corner) stands for the peak hour.

The resource management system 160 assumes that the workload classes obtained in the profiling environment are also relevant for the production system 120. This does not mean that the counter values reported by the profiler 164 need to be comparable to corresponding values seen by the service in the production system 120. This would be too strong of an assumption, as the resource management system 160 would then have to make the profiling environment a verbatim copy of the hosting platform, which is most likely infeasible. Instead, the resource management system 160 may only assume that the relative ordering among workloads is preserved between the profiling environment and the production system 120. For instance, if workload A is closer to workload B than to workload C in the profiling environment, the same also holds in the production environment. We have verified this assumption empirically using machines of different types in our lab

After the resource management system 160 identifies the workload classes, it triggers the tuning process for a single workload from each workload class. In some embodiments, the tuner 166 chooses the instance that is closest to the cluster's centroid. The tuner 166 may determine the sufficient, but not wasteful, set of virtualized resources (e.g., number and type of virtual instances) that ensure the application meets its SLO. The tuner 166 can use modeling or experiments for this task. Moreover, it can be manually driven or entirely automated. Many options for the tuning mechanism can be used. After the tuner 166 determines resource allocations for each workload class, the resource management system 160 has a table populated with workload signatures along with their preferred resource allocations—the workload signature repository—which it can re-use at runtime. The table may be stored at any suitable location of the resource management system 160, such as in the storage element 174.

To determine the resource allocations for each workload class, one or more techniques may be used. In one embodiment, a linear search can be used. That is, a sequence of runs of the workload may be replayed, each time with an increasing amount of virtual resources. The minimal set of resources that fulfill the target SLO may then be chosen. For instance, one can incrementally increase the CPU or memory allocation (by varying the VMM's scheduler caps) until the SLO is fulfilled. Since our experiments involve EC2, we can only vary the number of virtual instances or instance type. One skilled in the art would recognize that the tuning process may be accelerated using more sophisticated methods.

### 1.4. Quickly Adapting to Workload Changes

Since one of the goals of using the resource management system 160 is to reuse resource allocation decisions at runtime, there should be a mechanism to decide to which cluster a newly encountered workload belongs—the equivalent of the cache lookup operation. The resource management system 160 uses the previously identified clusters to label each workload with the cluster number to which it belongs, such that it can train a classifier 170 to quickly recognize newly encountered workloads at runtime. The resulting classifier may stand as the explicit description of the workload classes. We experimented with numerous classifier implementations from the WEKA package and observe that both Bayesian models and decision trees work well for the network services we considered. In specific embodiments, we use the C4.5 decision tree in our evaluation, or more precisely its open source Java implementation—J48.

Upon a workload change, the resource management system 160 promptly collects the relevant low-level metrics to form the workload signature of the new workload and queries the repository to find the best match among the existing signatures. To do this, it uses the previously defined classification model and outputs the resource allocation of the cluster to which the incoming signature belongs. Given that the number of workload classes is typically small and the classification time practically negligible, the resource management system 160 can adjust to workload changes on the order of a few or several seconds as needed by the profiler 164 to collect the workload signatures.

Along with the preferred resource allocations, the repository may also output the certainty level with which the repository assigned the new signature to the chosen cluster. If the repository repeatedly outputs low certainty levels, it most likely means that the workload has changed over time and that the current clustering model is no longer relevant. The resource management system 160 can then initiate the clustering and tuning process once again, allowing it to determine new workload classes, conduct the necessary experiments (or modeling activities), and update the repository. Meanwhile, the resource management system 160 may configure the service with the maximum allowed capacity to ensure that the performance is not affected when experiencing non-classified workloads.

### 1.5. Addressing Interference

In the previous section, we described how to populate the repository with the smallest (also called baseline) resource allocation that meets the SLO at the time of tuning

The baseline allocation however, due to interference, may not guarantee sufficient performance at all times. The resource management system 160 can deal with this problem by estimating the interference index and using it, along with the workload signature, when determining the preferred resource allocation.

In more detail, after the resource management system 160 deploys the baseline resource allocation for the current workload, it may monitor the resulting performance (e.g., service latency). If it observes that the SLO is still being violated, the resource management system 160 blames interference for the performance degradation. Workload changes are excluded from the potential reasons because the workload class has just been identified in isolation. It may then proceed to compute the interference index as in Equation 2.

$${Interference}_{index} = \frac{{PerformanceLevel}_{production}}{{PerformanceLevel}_{isolation}} \qquad ( Eqn . 2 )$$

The index contrasts the performance of the service in production obtained after the baseline allocation is deployed with that obtained from the profiler 164. Note that the resource management system 160 relies on each application to report a performance-level metric (e.g., response time, throughput). This metric already needs to be collected and reported when the performance is unsatisfactory. In some embodiments, this metric may be computed. Further, some applications may already compute software counters that express their “happiness level.” For instance, the Apache front-end computes its throughput, the .NET framework provides managed classes that make the reading and providing data for performance counters straightforward, etc.

Finally, the resource management system 160 queries the repository for the preferred resource allocation for the current workload and interference amount. If the repository does not contain the corresponding entry, the resource management system 160 may trigger the tuning process and send the obtained results, along with the estimated index, to the repository for later use. After this is done, the resource management system 160 may be able to quickly lookup the best resource allocation for this workload given the same amount of interference.

In some embodiments, interference may vary across the VM instances of a service, making it hard to select a single instance for profiling that will uniquely represent the interference across the entire service. Inspired by typical performance requirements (e.g., the Xth—percentile of the response should be lower than Y seconds), a selection process may be provided that chooses an instance at which interference is higher than in X % of the probed instances. This conservative performance estimation provides a probabilistic guarantee on the service performance. Accordingly, in some embodiments, the resource management system 160 may quantify the interference impact and react upon it to maintain the SLO.

### 1.6. Deployment Discussion

We discuss in this section operating details for at least two deployment scenarios.

Deployment might be where the resource management system 160 is operated by the cloud provide or by a third party.

Where a third party runs the resource management system 160, users may have to explicitly contract with both the provider and the third party. Alternatively the proxy 140 could be configured to selectively duplicate the incoming traffic such that private information (e.g., e-mails, user-specific data, etc.) is not dispatched to the profiler 162. However, having to share the service code with the third party may be a problem.

Where the cloud provider runs the resource management system 160, this deployment scenario eliminates the privacy and network traffic concerns with shipping code (clones of the services' VMS) and client requests to a third party.

Regardless of who runs the resource management system 160, a tenant needs to reveal certain information about their service. Specifically, the proxy 140 needs to know the port numbers used by the service to communicate with the clients and internally, among VMs. Finally, to completely automate the resource allocation process, the resource management system 160 may assume that it can enforce a chosen resource allocation policy without necessitating user involvement. Amazon EC2, for instance, allows the number of running instances to be automatically adjusted by using its APIs.

When unforeseeable workloads are encountered, the resource management system 160 provides no worse performance than the existing approaches when it encounters a previously unknown workload (e.g., large and unseen workload volume). In this case, the resource management system 160 may have to spend additional time to identify the resource allocation that achieves the desired performance at minimal cost (just like the existing systems). To try to avoid an SLO violation by the service, the resource management system 160 may respond to unforeseen workloads by deploying the maximum resource allocation (full capacity). If the workload occurs multiple times, the resource management system 160 may invoke the tuner 166 to compute the minimal set of required resources and then readjust the resource allocation.

Although the resource management system 160 primarily targets the “request-response” Internet services, the interference mechanism can also be useful for long-running batch workloads (e.g., MapReduce/Hadoop jobs). In this case, the resource management system 160 would use the equivalent of an SLO. For example, for Hadoop Map tasks, the SLO could be their user-provided expected running times (possibly as a function of the input size). Upon an SLO violation, the resource management system 160 may run a subset of tasks in isolation to determine the interference index. This computation would also expose cases in which interference is not significant and the user simply misestimated the expected running times.

### 2. Particular Methods of Operation

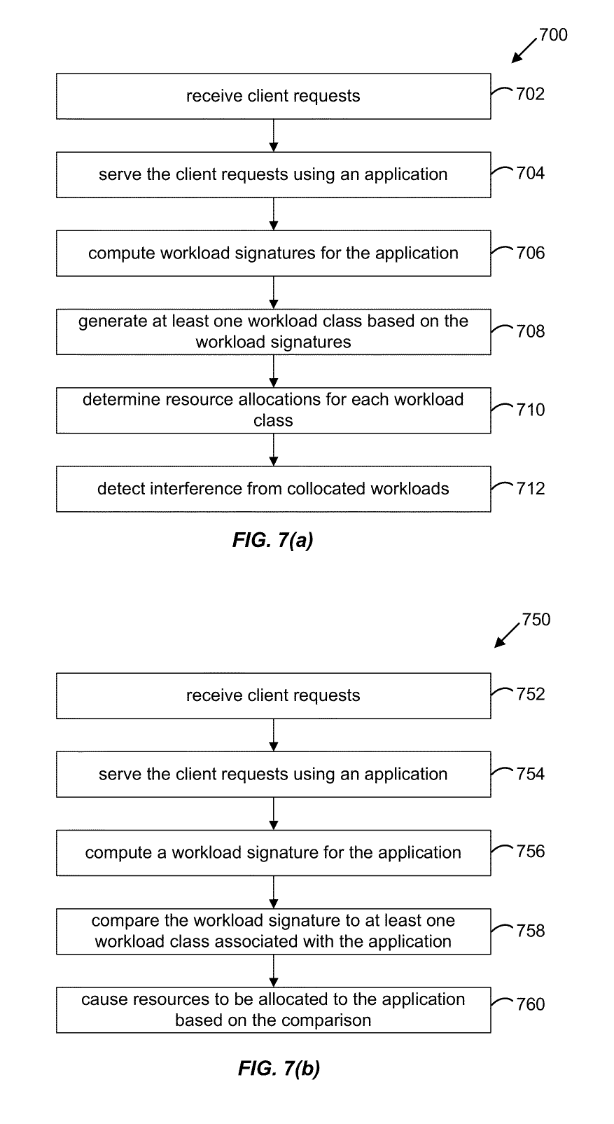

FIGS. 7(a) and 7(b) depict sequences of operations that may be performed instead of, in addition to, or in combination with any of the functions described herein.

Specifically, FIG. 7(a) shows a sequence of operations 700 for modeling an application or service. For example, these operations may be used to model an application or service executing on a production system 120 during, e.g., a learning phase. The operations may be performed by a computing device or system such as resource management system 160.

In operation 702, a number of client requests are received by the resource management system 160. The client requests may be sent from the client computing device 100 and be directed to the application or service provided by the production system 120. The client requests may be received from the client computing device 100 by the proxy server 140. The proxy server may then duplicate some or all of the client requests, forwarding the client requests to the production system 120 and sending the duplicates to the resource management system 160, such that the received client requests are only a portion of all client requests communicated to the application during a specified time. In some embodiments, the client requests may be received by the monitor 162 of the resource management system 160 during a learning phase.

In operation 704, the client requests are served using an application. In one embodiment, the client requests are served by a clone of the application or service provided by the production system 120, where the clone is provided by the resource management system 160. For example, the clone may be provided by monitor 162 and/or profiler 164. The clone may represent part or all of the application or service provided by the production system 120, and in some embodiments may be updated periodically or on-demand. In other embodiments, the client requests may be served directed by the application or service provided by the production system 120. In at least one embodiment, the client requests may be directed to a multi-tier architecture, and serving the client requests may include the profiler 164 sending requests concerning non-profiled tiers back to the proxy server 140.

In operation 706, workload signatures are computed for the application or service. For example, the profiler 164 may compute workload signatures from one or more workloads that are generated as a result of the client requests being served. In some embodiments, the workload signatures may be for each workload of a clone of the application that results from the clone serving the client requests, whereas in other embodiments the workload signatures may be for each workload of the application that results from the application directly serving the client requests. The workload signatures may be computed using hardware performance counters, attributes such as CPU, memory, input/output, cache, bus queue, or other suitable hardware characteristics of the computing device(s) which the application or service (and in some embodiments, the clone) is executing on.

In operation 708, at least one workload class is generated based on the workload signatures. In one embodiment, the workload classes are generated by clustering the workloads. For example, the clusterer 168 may cluster the workloads profiled by the profiler 164.

In operation 710, resource allocation are determined for each workload class. For example, the tuner 166 (i.e., resource allocator) may determine the appropriate workload allocations for each workload class generated in operation 708. The tuner 166 may then store a mapping between the workload allocations and each workload class in a resource allocation map provided in, e.g., storage element 174.

In operation 712, interference from collocated workloads may be detected. For example, the interference detector 172 may detect interference from collocated workloads. In one embodiment, such interference may be detected by contrasting the performance clone with the performance of the application. The interference detector 172 may then generate an index indicating a resource multiplication factor indicative of the amount of resources needed to account for the interference and, ion some embodiments, store the interference index in the resource allocation map and associate the interference index with the corresponding workload signature and resource allocation.

FIG. 7(b) shows a sequence of operations 750 for allocating resources to an application. For example, these operations may be used by resource management system 160 to cause the production system 120 to change the number of resources allocated to an application or service provided by the production system 120 to a user associated with the client computing device 100. Resources may include, for example, storage space, processor time, network bandwidth, etc., allocated to the application or service.

In operation 752, a number of client requests are received by the resource management system 160. The client requests may be sent from the client computing device 100 and be directed to the application or service provided by the production system 120. The client requests may be received from the client computing device 100 by the proxy server 140. The proxy server may then duplicate some or all of the client requests, forwarding the client requests to the production system 120 and sending the duplicates to the resource management system 160, such that the received client requests are only a portion of all client requests communicated to the application during a specified time. In some embodiments, the client requests may be received by the monitor 162 of the resource management system 160 during a re-use phase that is engaged subsequent to the learning phase.

In operation 754, the client requests are served using an application. In one embodiment, the client requests are served by a clone of the application or service provided by the production system 120, where the clone is provided by the resource management system 160. For example, the clone may be provided by monitor 162 and/or profiler 164. The clone may represent part or all of the application or service provided by the production system 120, and in some embodiments may be updated periodically or on-demand. In other embodiments, the client requests may be served directed by the application or service provided by the production system 120.

In operation 706, a workload signature is computed for the application or service. For example, the profiler 164 may compute a workload signature from the workload that is generated as a result of the client requests being served. In some embodiments, the workload signature may be for the workload of a clone of the application that results from the clone serving the client requests, whereas in other embodiments the workload signature may be for the workload of the application that results from the application directly serving the client requests. The workload signature may be computed using hardware performance counters, attributes such as CPU, memory, input/output, cache, bus queue, or other suitable hardware characteristics of the computing device(s) which the application or service (and in some embodiments, the clone) is executing on.

In operation 758, the workload signature is compared to at least one workload class associated with the application. For example, the classifier 170 may read the various workload signatures from the resource allocation map 310 and compare the generated workload signature to the workload signatures provided in the map. If there is a match between the computed workload signature and one of those provided in the map 310, the resource allocation associated with the workload signature provided in the map 310 is used to reallocate the resources of the production system 120. In some embodiments, the classifier 170 may execute a classification algorithm that classifies the workload signature, where the classification algorithm uses the workload signatures in the resource allocation map 310 as training points. In at least one embodiment, comparing the workload signature to the workload class associated with the application includes determining a certainty level indicating an amount of certainty with which the workload signature matches the workload class. Such a certainty level may be generated, for example, by the classification algorithm.

In operation 760, resources are caused to be allocated to the application or service based on the comparison. In some embodiments, the resource management system 160 may send one or more instructions to the production system 120 instructing the production system 120 to change its resource allocation to the application or services provided to the user associated with the client computing device 100. With reference to operation 758, in the event that there is a match between the computed workload signature and one of those provided in the map 310, the resource allocation associated with the workload signature provided in the map 310 is read and used to reallocate the resources of the production system 120. In contrast, when there is no match between the computed workload signature and those provided in the map 310, the resource management system 160 may perform one or more other operations, such as performing additional modeling of the application or service, performing sandboxed experimentation, performing online experimentation, and/or causing a full capacity configuration to be deployed for the application. In some embodiments, allocating resources may include adjusting for interference. For example, an interference index may be read from the map 310 and used to adjust the amount of resources allocated to the application or service.

It should be appreciated that the specific operations illustrated in FIGS. 7(a) and 7(b) provide a particular methods according to certain embodiments of the present invention. Other sequences of operations may also be performed according to alternative embodiments. For example, alternative embodiments of the present invention may perform the operations outlined above in a different order. Moreover, the individual operations illustrated in FIGS. 7(a) and 7(b) may include multiple sub-operations that may be performed in various sequences as appropriate to the individual step. Furthermore, additional operations may be added or existing steps removed depending on the particular applications. One of ordinary skill in the art would recognize and appreciate many variations, modifications, and alternatives.

### 3. Evaluation and Test Results

This evaluation section describes results of tests using specific embodiments of resource management systems, and is not meant to limit the implementation of embodiments described elsewhere herein.

The resource management system 160 uses realistic traces and workloads to determine whether it can produce significant savings while scaling network services horizontally (scaling out) and vertically (scaling up) and how the resource management system 160 compares with: i) a time-based controller that attempts to leverage the reoccurring (e.g., daily or monthly) patterns in the workload by repeating the resource allocations determined during the learning phase at appropriate times, and/or ii) an existing autoscaling platform, such as RightScale. The tests also determined whether the resource management system 160 is capable of detecting and mitigating the effect of interference, as well as whether the profiling overhead affects the performance of the production system 120.

In these tests, the following testbed was used: Two servers—Intel SR1560 Series rack servers with Intel Xeon X5472 processors (eight cores at 3 GHz), 8 GB of DRAM, and 6 MB of L2 cache per every two cores. These are used to collect the low-level metrics while hosting the clone instances of Internet service components.

We evaluated the resource management system 160 by running widely-used benchmarks on Amazon's EC2 cloud platform. We ran all our experiments within an EC2 cluster of 20 virtual machines (both clients and servers were running on EC2). To demonstrate the resource management system's ability to scale out, we varied the number of active instances from 2 to 10 as the workload intensity changes, but resorted only to EC2's large instance type. In contrast, we demonstrated its ability to scale up by varying the instance type from large to extra-large, while keeping the number of active instances constant.

To focus on the resource management system 160 rather than on the idiosyncrasies of EC2, our scale out experiments assume that the VM instances to be added to a service have been pre-created and stopped. In our scale up experiments, we also pre-create VM instances of both types (large and extra large). Pre-created VMs are ready for instant use, except for short warm-up time. In all cases, state management across VM instances, if needed, is the responsibility of the service itself, not the resource management system 160.

Internet services. We evaluated the resource management system 160 for two representative types of Internet services: 1) a classic multi-tier website with an SQL database backend (SPECweb2009), and 2) a NoSQL database in the form of a key-value storage layer (Cassandra).

SPECweb2009 is a benchmark designed to measure the performance of a web server serving both static and dynamic content. Further, this benchmark allows us to run 3 workloads: e-commerce, banking and support. While the first two names speak for themselves, the last workload tests the performance level while downloading large files.

Cassandra differs significantly from SPECweb2009. It is a distributed storage facility for maintaining large amounts of data spread out across many servers, while providing highly available service without a single point of failure. Cassandra is used by many real Internet services, such as Facebook and Twitter, whereas the clients to stress test it are part of the Yahoo! Cloud Service Benchmark.

In section 1.3, we also profile RUBiS, a three--tier e-commerce application (given its similarity to SPECweb2009, we do not demonstrate the rest of the resource management system's features on this benchmark). RUBiS comprises a front-end Apache web server, a Tomcat application server, and a MySQL database server. In short, RUBiS defines 26 client interactions (e.g., bidding, selling, etc.) whose frequencies are defined by RUBiS transition tables. Our setup has 1,000,000 registered clients and that many stored items in the database, as defined by the RUBiS default property file.

Given that these are widely-used benchmarks, client emulators are publicly available for all of them and we use them to generate client requests. Each emulator can change the workload type by varying its “browsing habits”, and also collect numerous statistics, including the throughput and response time which we use as the measure of performance. Finally, all clients run on Amazon EC2 instances to ensure that the clients do not experience network bottlenecks.

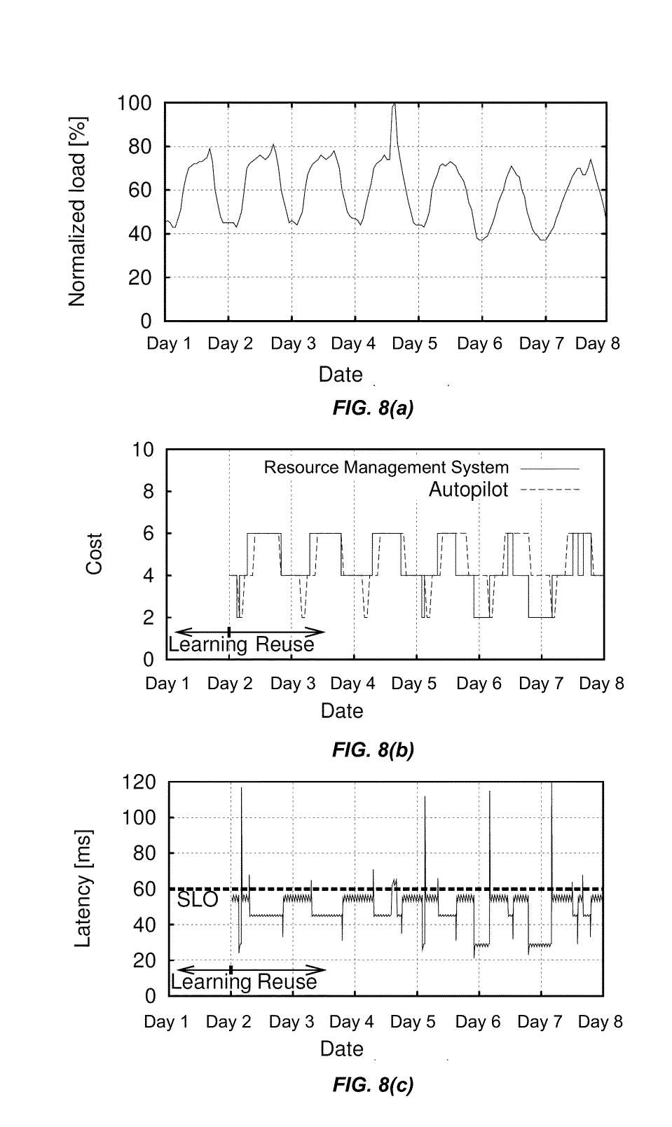

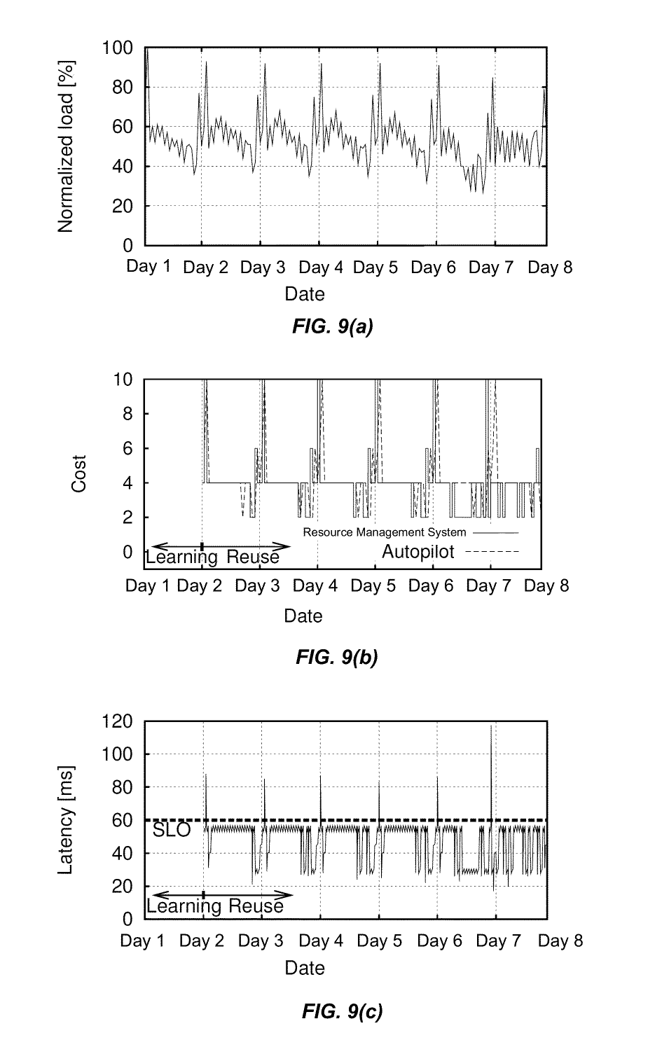

Workload Traces. To emulate a highly dynamic workload of a real application, we use real load traces from HotMail (Windows Live Mail) and Windows Live Messenger. FIGS. 8(a) and 9(a) plot the normalized load from these traces. Both traces contain measurements at 1-hour increments during one week, aggregated over thousands of servers. We proportionally scale down the load such that the peak load from the traces corresponds to the maximum number of clients that we can successfully serve when operating at full capacity (10 virtual instances).

In all our experiments, we use the first day from our traces for initial tuning and identification of the workload classes, whereas the remaining 6 days are used to evaluate the performance/cost benefits when the resource management system is used.

### 3.1. Case Study 1—Adapting to Workload Changes by Scaling Out

Our first set of experiments demonstrates the resource management system's ability to reduce the service provisioning cost by dynamically adjusting the number of running instances (scale out) as the workload intensity varies according to our live traces. We show the resource management system's benefits with Cassandra's update-heavy workload which has 95% of write requests and only 5% of read requests.

FIG. 8(b) plots how the resource management system varies the number of active server instances as the workload intensity changes according to the Messenger traces. The initial tuning produces four different workload classes and ultimately four preferred resource allocations that are obtained using the tuner . The resource management system collects the workload signature every hour (dictated by the granularity of the available traces) and classifies the workload to promptly re-use the preferred resource allocation.

FIG. 8(c) shows the response latency in this case. The SLO latency is set to 60 ms. Although this is masked by the monitoring granularity, we note that Cassandra takes a long time to stabilize (e.g., tens of minutes) after the resource management system adjusts the number of running instances. This delay is due to Cassandra's repartitioning, a well-known problem that is the subject of ongoing optimization efforts. Apart from Cassandra's internal issues, the resource management system keeps the latency below 60 ms, except for short periods when the latency is fairly high—about 100 ms. These latency peaks correspond to the resource management system's adaptation time, around 10 seconds, which is needed by the profiler to collect the workload signature and deploy a new preferred resource allocation. Note that this is still 18 times faster than the reported figures of about 3 minutes for adaptation to workload changes by state-of-the-art experimental tuning

We conducted a similar set of experiments, but drove the workload intensities using the HotMail Traces. FIGS. 9(b) and 9(c) visualize the cost (in number of active instances) and latency over time, respectively. While the overall savings computed to the maximum allocation are again similar (60% over the 6-day period), there are few points to note. First, the initial profiling identified three workload classes for the HotMail traces, instead of four for the Messenger traces. Second, during the fourth day, the resource management system could not classify one workload with the desired confidence, as it differs significantly from the previously defined workload classes. The reason is that the initial profiling had not encountered such a workload in the first day of the traces. To avoid performance penalties, the resource management system can be configured to use the full capacity to accommodate this workload. If this scenario were to re-occur, the resource management system would resort to repeating the clustering process.

3.1.1. Comparison with Existing Approaches.

Next, we compared the resource management system's behavior with that of two other approaches. FIGS. 8(b) and 9(b) depict the resource allocation decisions taken by Autopilot. Specifically, Autopilot simply repeats the hourly resource allocations learned during the first day of the trace. The Autopilot approach leads to suboptimal resource allocations and the associated provisioning cost increases. Due to poor allocations, as shown in FIG. 8(b), Autopilot violates the SLO at least 28% of the time, in both traces. These measurements illustrate the difficulty of using past workload information blindly.

We further compared the resource management system with an existing autoscaling platform called RightScale, reproduced based on publicly available information. The RightScale algorithm reacts to workload changes by running an agreement protocol among the virtual instances. If the majority of VMs report utilization that is higher than the predefined threshold, the scale-up action is taken by increasing the number of instances (by two at a time, by default). In contrast, if the instances agree that the overall utilization is below the specified threshold, the scaling down is performed (decrease the number of instances by one, by default). To ensure that the comparison is fair, we ran the Cassandra benchmark, which is CPU and memory intensive, as assumed by the RightScale default configuration.

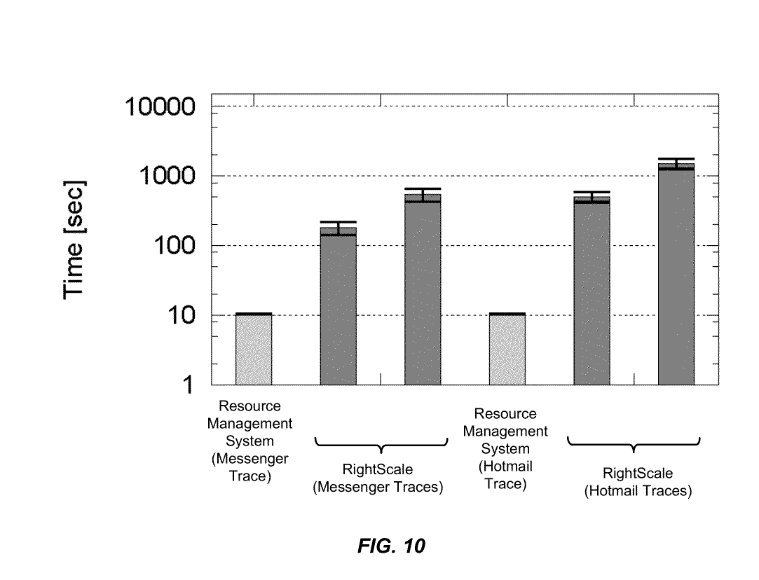

FIG. 10 shows the average adaptation time for the resource management system and RightScale (assuming its default configuration) for the Hotmail and Messenger traces. The error bars show the standard error. In case of RightScale we experimented with three minutes (the minimum value) and fifteen minutes (the recommended value) for the “resize calm time” parameter—the minimum time between successive RightScale adjustments. The three minute and fifteen minute parameter are shown in the middle RightScale trace and on the RightScale right trace, respectively.

The resource management system's reaction time is about 10 seconds (in the case of a “cache hit”). Note that this time can vary depending on the length of the workload signature (e.g., a larger number of HPCs may take longer to collect). RightScale's decision time is between one and two of orders of magnitude longer than the resource management system's (note the log scale on the Y axis). This is in part due to the ability of the resource management system to automatically jump to the right configuration, rather than gradually increase or decrease the number of instances as RightScale does. Note that the resize calm time is different in nature from the VM boot up time and cannot be eliminated for RightScale—RightScale has to first observe the reconfigured service before it can take any other action.

### 3.2. Case Study 2—Adapting to Workload Changes by Scaling Up

We next evaluated the resource management system's ability to reduce the service provisioning cost while varying the instance type (scaling up) from large to extra-large or vice versa, as dictated by the workload intensity. Toward this end, we monitored the SPECweb service with five virtual instances serving at the frontend, and the same number of them at the backend layer. We used the support benchmark, which is mostly I/O intensive and ready-only, to contrast with the Cassandra experiments which are CPU-, memory-, and write- intensive. Similar to the previous experiments, the resource management system uses the first day for the initial profiling/clustering, while the remaining days are used to evaluate its benefits.

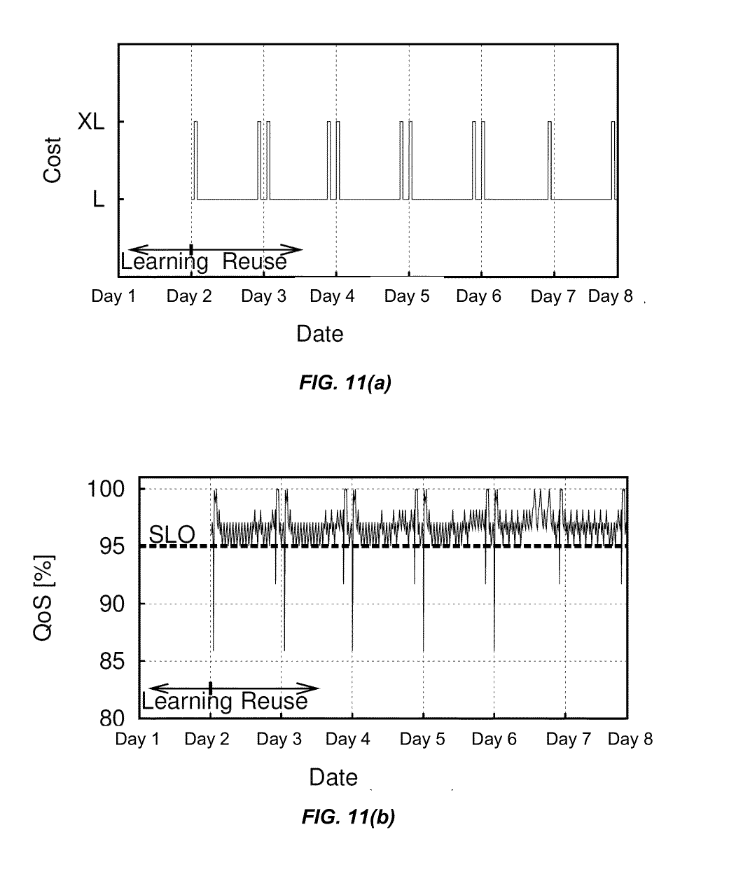

FIG. 11(a) plots the provisioning cost, shown as the instance type used to accommodate the HotMail load over time. Note that the smaller instance was capable of accommodating the load most of the time. Only during the peak load (two hours per day in the worst case), the resource management system deploys the full capacity configuration to fulfill the SLO. In monetary terms, the resource management system produced savings of roughly 45%, relative to the scheme that has to overprovision at all times with the peak load in mind. FIG. 11(b) shows the service latency as the resource management system adapts to workload changes. FIG. 11(b) demonstrates that the savings come with a negligible effect on the performance levels; the quality of service (QoS, measured as the data transfer throughput) is always above the target that is specified by the SPECweb2009 standard. The standard requires that at least 95% of the downloads meet a minimum 0.99 Mbps rate in the support benchmark for a run to be considered compliant.

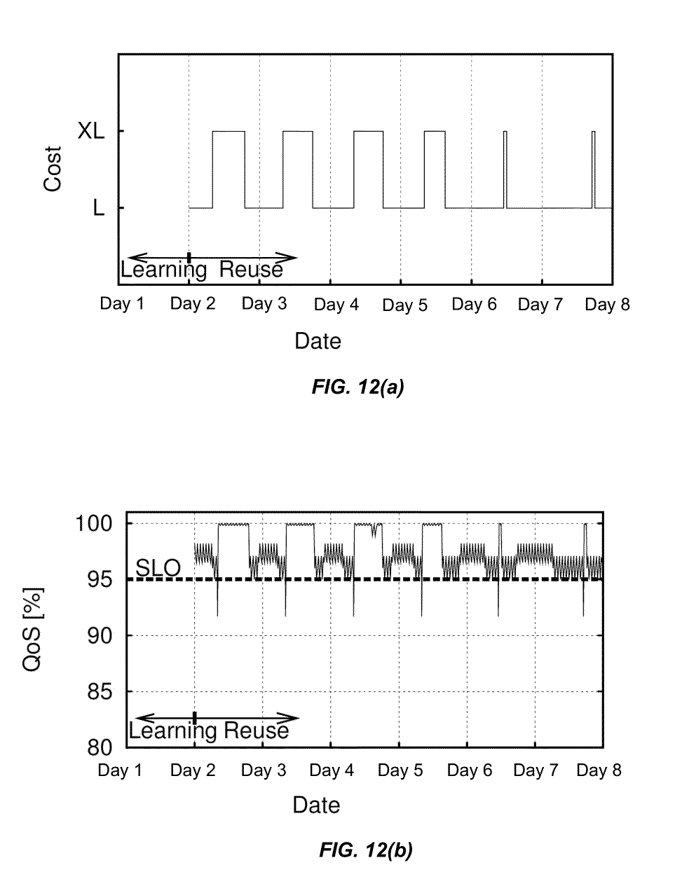

We further performed a similar set of experiments with the Messenger trace. In this case, FIGS. 12(a) and 12(b) show the provisioning cost and performance levels, respectively. The savings in this case are about 35% over the 6-day period. Excluding a few seconds after each workload change spent on profiling, QoS is as desired, above 95%.

### 3.3. Case Study 3—Addressing Interference

Our next experiments demonstrate how the resource management system detects and mitigates the effects of interference. We mimic the existence of a co-located tenant for each virtual instance by injecting into each VM a microbenchmark that occupies a varying amount (either 10% or 20%) of the VM's CPU and memory over time. The microbenchmark iterates over its working set and performs multiplication while enforcing the set limit.

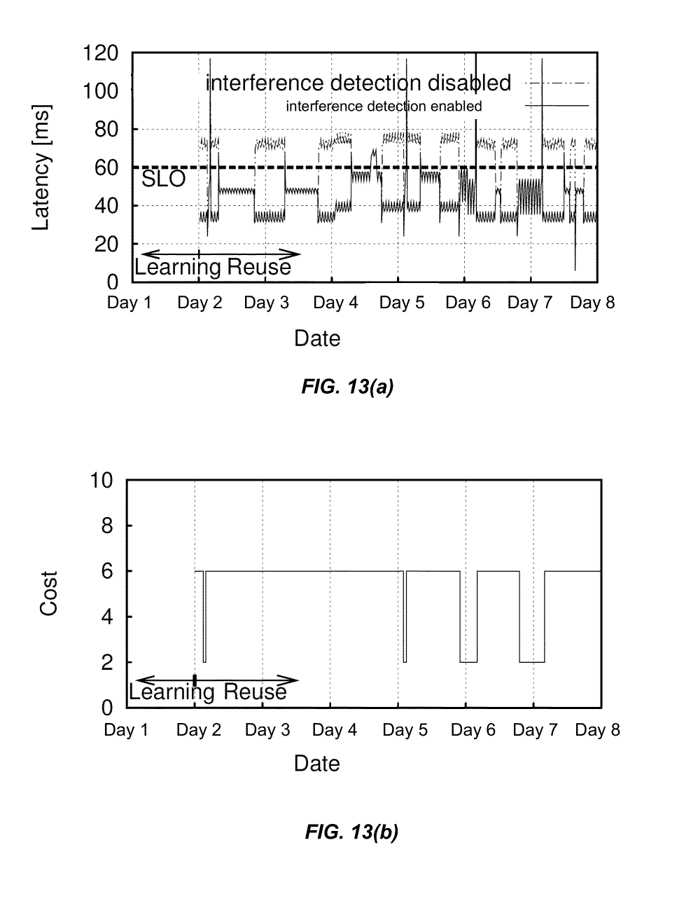

FIG. 13(a) contrasts the resource management system with an alternative in which its interference detection is disabled. Without interference detection, one can see that the service exhibits unacceptable performance most of the time. Recall that the SLO is 60 ms. In contrast, in the implementation used, the resource management system relied on its online feedback to quickly estimate the impact of interference and lookup the resource allocation that corresponded to the interference condition such that the SLO is met at all times. FIG. 13(b) shows the number of virtual instances used to accommodate the load when interference detection is enabled. FIG. 13(b) shows that the resource management system indeed provisions the service with more resources to compensate for interference.

### 3.4. Measuring the Resource Management System's Overhead

The resource management system requires only one or a few machines to host the profiling instances of the services that it manages. Its network overhead corresponds to the amount of traffic that it sends to the profiling environment. This overhead is roughly equal to 1/n of the incoming network traffic, where n is the number of service instances, assuming the worst case in which the proxy is continuously duplicating network traffic and sending it to the profiler. Given that the inbound traffic (client requests) is only a fraction of the outbound traffic (service responses) for typical services, the network overhead is likely to be negligible. For example, it would be 0.1% of the overall network traffic for a service that uses 100 instances assuming a 1:10 inbound/outbound traffic ratio that is typically used for home broadband connections.

One question of interest was to what extent the proxy affects the performance of the system in production, as it duplicates the traffic of a single service instance. To answer this question, we ran a set of experiments with the RUBiS benchmark, while profiling its database server instance. We compared the service latency under a setup where the profiling is disabled against a setup with continuous profiling. To exercise different workload volumes, we varied the number of clients that are generating the requests from 100 to 500. Our measurements showed that the presence of our proxy degrades response time by about 3 ms on average.

### 3.5. Summary

To summarize, our evaluation shows that the resource management system maps multiple workload levels to a few relevant clusters. It uses this information at runtime to quickly adapt to workload changes. The adaptation is short (about 10 seconds) and more than 10 times faster than other approaches. Having such quick adaptation times effectively enables online matching of resources to the offered load in pursuit of cost savings.

We demonstrated provisioning cost savings of 35-60% (compared to a fixed, maximum allocation) using realistic traces and two disparate and representative Internet services: key-value storage and a 3-tier web service. The savings are higher (50-60% vs. 35-45%) when scaling out (varying the number of machines) vs. scaling up (varying the performance of machines) because of the finer granularity of possible resource allocations. The scaling up case had only two choices of instances (large and extra-large) with a fixed number of instances vs. 1-10 identical instances when scaling out.

The resource management system successfully manages interference on the hosting platform by recognizing the existence of interference and pragmatically using more resources to compensate for it.

The achieved savings translate to more than $250,000 and $2.5 Million per year for 100 and 1,000 instances, respectively (assuming $0.34/hour for a large instance on EC2 and $0.68/hour for extra large as of July 2011).

In terms of overheads, the network traffic induced by the resource management system is negligible, while our final experiments demonstrate that the resource management system's impact on the performance of the system in production is also practically negligible.

### 4. Computer Apparatus

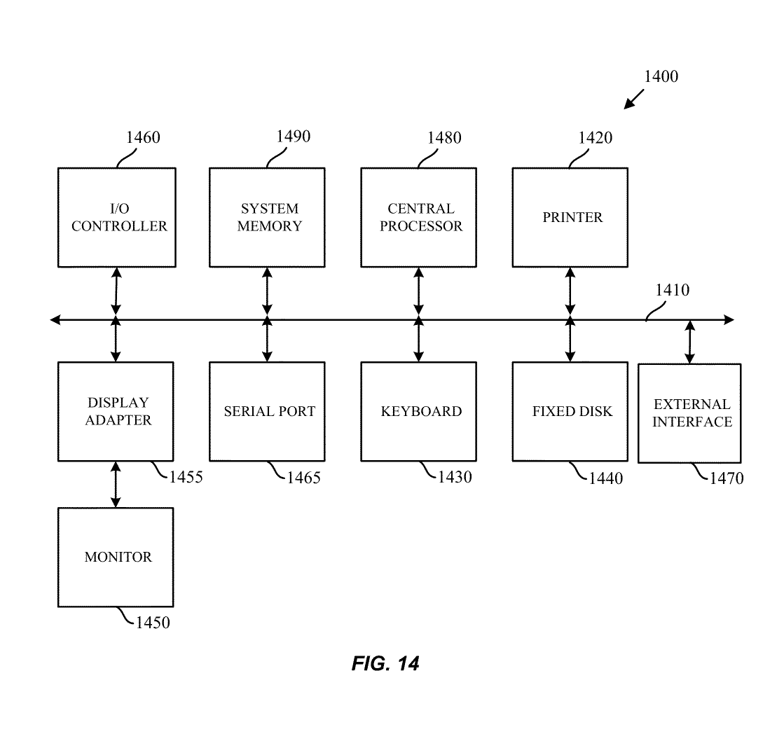

FIG. 14 is a diagram of a computer apparatus 1400, according to an example embodiment. The various participants and elements in the previously described system diagrams (e.g., the client computing device 100, production system 120, proxy server 140, and/or resource management system 160) may use any suitable number of subsystems in the computer apparatus to facilitate the functions described herein. Examples of such subsystems or components are shown in FIG. 14. The subsystems shown in FIG. 14 are interconnected via a system bus 1410. Additional subsystems such as a printer 1420, keyboard 1430, fixed disk 1440 (or other memory comprising tangible, non-transitory computer-readable media), monitor 1450, which is coupled to display adapter 1455, and others are shown. Peripherals and input/output (I/O) devices (not shown), which couple to I/O controller 1460, can be connected to the computer system by any number of means known in the art, such as serial port 1465. For example, serial port 1465 or external interface 1470 can be used to connect the computer apparatus to a wide area network such as the Internet, a mouse input device, or a scanner. The interconnection via system bus allows the central processor 1480 to communicate with each subsystem and to control the execution of instructions from system memory 1490 or the fixed disk 1440, as well as the exchange of information between subsystems. The system memory 1490 and/or the fixed disk 1440 may embody a tangible, non-transitory computer-readable medium.

### 5. Conclusion

The problem of resource allocation is challenging in the cloud, as the co-located workloads constantly evolve. The result is that system administrators find it difficult to properly manage the resources allocated to the different virtual machines, leading to suboptimal service performance or wasted resources for significant periods of the time.

The design and implementation of a resource management system (and proxy server) as described herein can quickly and automatically react to workload changes by learning the preferred virtual resource allocations from past experience, where the past experience can be the experience of the cloud environment, the past experience of a specific tenant, or past experiences of multiple tenants. Further, the described resource management system may also detect performance interference across virtual machines and adjust the resource allocation to counter it.

It should be recognized that the software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

The use of the terms “a” and “an” and “the” and similar referents in the context of describing embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope unless otherwise claimed. No language in the specification should be construed as indicating any non-claimed element as essential to the practice of at least one embodiment.

Preferred embodiments are described herein, including the best mode known to the inventors. Variations of those preferred embodiments may become apparent to those of ordinary skill in the art upon reading the foregoing description. The inventors expect skilled artisans to employ such variations as appropriate, and the inventors intend for embodiments to be constructed otherwise than as specifically described herein. Accordingly, suitable embodiments include all modifications and equivalents of the subject matter recited in the claims appended hereto as permitted by applicable law. Moreover, any combination of the above-described elements in all possible variations thereof is contemplated as being incorporated into some suitable embodiment unless otherwise indicated herein or otherwise clearly contradicted by context. The scope of the invention should, therefore, be determined not with reference to the above description, but instead should be determined with reference to the pending claims along with their full scope or equivalents.

What is claimed is:

1. A resource management system usable in distributed computing environments wherein computing resources are allocated among a plurality of applications that would consume those computing resources and are allocated portions of those computing resources, the resource management system comprising:
a monitor operable to receive client requests directed to an application;
a profiler operable to compute a workload signature for each workload of a clone of the application that results from the clone serving the client requests;
a clusterer operable to cluster workloads; and
a tuner operable to map each cluster to a resource allocation.

2. The resource management system of claim 1, further comprising an interference detector that detects interference from collocated workloads.

3. The resource management system of claim 2, wherein the interference detector detects interference by contrasting the performance of the clone with the performance of the application.

4. The resource management system of claim 2, wherein when the interference detector detects interference from collocated workloads, the interference detector generates an index indicating a resource multiplication factor indicative of the amount of resources needed to account for the interference.

5. The resource management system of claim 1, wherein the application is part of a multi-tier service executing on an application server coupled to a database, requests to and answers from the database are stored and used to simulate database requests by the profiler.

6. A resource management system usable in distributed computing environments wherein computing resources are allocated among a plurality of applications that would consume those computing resources and are allocated portions of those computing resources, the resource management system comprising:
a monitor operable to receive client requests directed to an application;
a profiler operable to compute a workload signature for a workload of a clone of the application that results from the clone serving the client requests;
a classifier operable to classify the workload signature using previously defined workload classes; and
a resource allocator operable to cause a number of resources to be allocated to the application defined by a resource allocation associated with a workload class that matches the workload signature.

7. The resource management system of claim 6, further comprising an interference detector operable to detect interference from collocated workloads and adjust the number of resources allocated to the application based on the detected interference.

8. The resource management system of claim 6, wherein resources include one or more of storage space, processor time, and network bandwidth.

9. The resource management system of claim 6, wherein the workload signature is a vector of metrics describing the workload characteristics of the clone.

10. The resource management system of claim 9, wherein the metrics include one or more of: hardware performance counters, central processing unit, memory, input/output, cache, and bus queue.

11. A method of modeling an application in a distributed computing environment wherein computing resources are allocated among a plurality of applications that would consume those computing resources and are allocated portions of those computing resources, the method comprising:
receiving client requests at a computing device;
serving the client requests using an application at the computing device;
computing workload signatures for the application;
generating at least one workload class based on the workload signatures; and
determining resource allocations for each workload class.

12. The method of claim 11, wherein the application is a clone of an application to which the client requests are directed.

13. The method of claim 11, wherein only the received client requests are only a portion of all client requests communicated to the application during a specified time period.

14. The method of claim 11 wherein the workload signatures are computed using at least one hardware characteristic of a computing device which the application is executing on.

15. The method of claim 11 wherein generating at least one workload class includes clustering the workload signatures.

16. A method of allocating resources to an application in a distributed computing environment wherein computing resources are allocated among a plurality of applications that would consume those computing resources and are allocated portions of those computing resources, the method, comprising:
receiving a client request at a computing device;
serving the client request using the application at the computing device;
computing a workload signature for the application;
comparing the workload signature to at least one workload class associated with the application; and
causing resources to be allocated to the application based on the comparison.

17. The method of claim 16, wherein comparing the workload signature to at least one workload class associated with the application includes executing a classification algorithm that classifies the workload signature.

18. The method of claim 16, further comprising determining a certainty level indicating an amount of certainty with which the workload signature matches a workload class.

19. The method of claim 16, wherein causing resources to be allocated to the application includes reading a stored resource allocation associated with a workload class that matches the workload signature.

20. The method of claim 16, wherein causing resources to be allocated to the application includes, when the workload signature does not match any of the at least one workload class, performing steps selected from the group consisting of:
additional modeling of the application;
sandboxed experimentation;
online experiment; and
deploying a full capacity configuration for the application.
